(19) United States
(12) Patent Application Publication
(10) Pub. No.: US 2006/0018301 A1
(43) Pub. Date: Jan. 26, 2006

(54) Method of establishing multi-homed connections in networks with address conversion

(75) Inventor: Wolfgang Schrufer, Karlsfeld (DE)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/183,690

(22) Filed: Jul. 18, 2005

Related U.S. Application Data
(60) Provisional application No. 60/589,687, filed on Jul. 21, 2004.

(30) Foreign Application Priority Data
Jul. 21, 2004 (EP) 04017217.3

(51) Int. Cl. H04L 12/28

(52) U.S. Cl. 370/351

(57) ABSTRACT

The invention relates to a method for establishing a multi-homed connection with a number n of paths between two components of a communication network. In this case the components feature at least n communication addresses, and the communication addresses of at least a first component are translated in the connection path. The method features the following steps: Determination by the components of n translation relationships of the n communication addresses provided for the n paths; and setting up the multi-homed connection through establishing the n paths on the basis of the translation relationships determined. The n translation relationships are exchanged completely or partly in each case by the exchange of test messages for k (k=1 . . . n) communication addresses between the components, which deliver k translation relationships. In this case the test messages are selected so that the translation of the communication addresses for test messages is identical to the translation of the communication addresses for the later paths of the multi-homed connection. Alternatively translation relationships can be determined by setting up m (m=1 . . . n) single-homed connections between the components. In this case there can preferably be provision, to prevent a multiple setup and cleardown of connections or paths, for the single-homed data connections to be merged as paths into the multi-homed connection.

### CROSS REFERENCE TO RELATED APPLICATIONS

This application claims priority to the U.S. Provisional application No. 60/589,687, filed Jul. 21, 2005 and to the European application No. 04017217.3. Both applications are incorporated by reference herein in their entirety.

### FIELD OF THE INVENTION

The present invention relates to a method of establishing multi-homed connections, with a conversion of the communication addresses taking place in the connection path. The invention especially relates to a method of establishing an SCTP connection with a number of paths in networks with Network Address Translation (NAT).

### SUMMARY OF THE INVENTION

Communication networks, in which communication protocols are used, where what are known as single-homed data connections always lead from precisely one end point to precisely one other end point, are very widespread nowadays. An example of one such communication protocol is the Internet Protocol IP with the protocols TCP and UDP based on it. In these protocols end points are identified by an IP address and a port number.

Frequently, as in the case of the widely-used IP communication networks, additional measures are required to create a reliable connection for end points and other network components connected to the communication network, such as redundant linkage to the communication network. In this case however the basic protocol mechanisms are seldom suitable for efficient administration and use of this redundant coupling, since the basic protocol mechanisms only provide single-homed data connections.

Efforts have been and will be made therefore to create communication protocols which—based on the basic protocols—give applications implemented on end points and other network components the option of defining a number of own communication addresses for a connection. A number of communication addresses can for example be provided in the paths of a number of network cards. If a network components can use for a connection a number of separate (and if nec. remote) communication addresses, this is frequently referred to as multihoming or as multi-homed connections.

An example of such a communication protocol with expanded capabilities for use in IP communication networks is the Session Control Transmission Protocol SCTP, defined in IETF RFC 2960.

FIG. 1 shows a typical IP communication network 100 with a first end point or host A 102 and a second end point or host B 112, each of which has two (global) IP addresses 104A, 104B and 114A, 114B. An (SCTP) connection between the end points is formed by two paths 108A, 108B which are preferably different, i.e. run via different routers 106A, 106B through the communication network which can also include a Wide Area Network WAN 110. The SCTP protocol or a similar communication protocol administers and uses these two paths in such a way that the failure of one path, such as the failure of one of the routers 106, does not interrupt the end-to-end communication since the other path can be used immediately. The number of paths is not restricted to two in such cases.

A major disadvantage of the multi-homed connections lies in the fact that these can regularly not be established if in the connection path a translation of the communication addresses is undertaken, known for example for IP communication networks as Network Address Translation (NAT) defined in IETF RFC 1631. In general a communication address can typically be translated in IP networks by modifying an IP address or a port number or by changing the two address components. In this case a receiver address and/or a transmitter address can be subject to address translation.

It is thus an object of the invention to specify a method for establishing a multi-homed connection if the communication addresses are being translated in the connection path.

This object is achieved by a method for establishing a multi-homed connection with a number of paths between two components of a communication network. In this case the components feature at least n communication addresses, and in the connection path the communication addresses of at least a first of the components are translated. The method features the following steps:
Determination by the components of n translation relationships of the n communication addresses provided for the n paths; and
Establishing the multi-homed connection by establishing the n paths on the basis of the translation relationships determined.

The translation relationship in such cases is frequently characterized by the fact that a local communication address of a first component is translated into a global communication address. Only the knowledge of this global address enables other components to address this first component. However, to do this, it is not necessary for the other components to know about the complex translation relationship, i.e. the local communication address as well as the global address. For a successful connection setup it is sufficient for the component translating the address e.g. a router, to know the complete translation relationship.

In this case the n translation relationships can each be determined completely or partly for example according to one of the following methods:
Exchange of test messages for k (k=1 . . . n) communication addresses between the components, which k deliver k translation relationships. In this case the test messages are selected so that the translation of the communication addresses for test messages is identical is to the translation of the communication addresses for the later paths of the multi-homed connection.
Establishing m (m=1 . . . n) single-homed connections between the components. In this case provision can preferably be made for linking these single-homed connections to the multi-homed connection in a further step as new paths.

The present invention further relates to components of a communication network which have software or hardware means available, to execute the method in accordance with the invention.

A communication protocol, which when used in conjunction with the present invention can be expanded especially advantageously, is the Stream Control Transmission Protocol SCTP.

A particular advantage of the invention is to be seen in the fact that it is possible to also establish multi-homed data connections via address converters, e.g. NAT routers which only support the standardized address conversion methods. In the case of the IP network this means that no changes have to be made at the NAT routers, so that the invention can be applied directly without changing the network infrastructure. Only the end points of SCTP associations must support the method.

The invention can advantageously also be used for dynamic reconfiguration of communication addresses, e.g. IP addresses, without an existing connection having to be interrupted. This can be of advantage for example for physical replacement of network cards, for dynamic address changes or for cordless applications.

The invention is explained below in greater detail in exemplary embodiments with reference to the Figures.

### BRIEF DESCRIPTION OF THE DRAWINGS

FIG. 1 shows in schematic diagram of a network with a connection with two paths via routers without address translation,

FIG. 2 shows in schematic diagram of a network with a connection with two paths via routers with address translation, and

FIGS. 3A-C show in schematic diagrams of the execution sequence for creating the connection from FIG. 2.

### DETAILED DESCRIPTION OF THE INVENTION

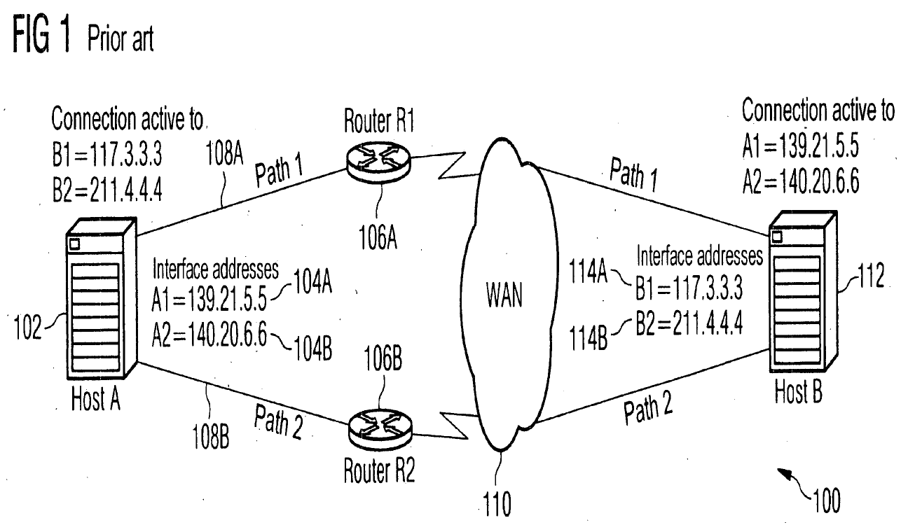

FIG. 1 shows, as already explained, the IP communication network 100, in which it presents no difficulty according to the prior art to establish and SCTP connection or SCTP association formed by two paths 108A, 108B, between the first end point 102 and the second end point which each have two (global) IP-addresses 104A, 104B and 114A, 114B.

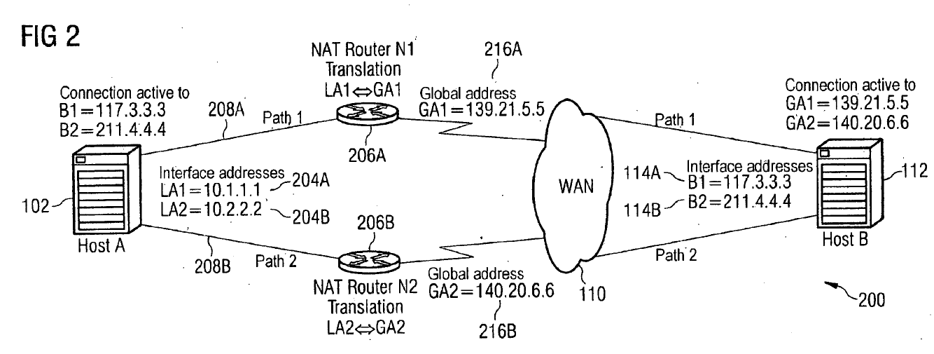

FIG. 2 shows a similar situation to FIG. 1, but with NAT routers 206A and 206B instead of the routers 106A and 106B. In detail FIG. 2 shows a typical IP communication network 200 with the first end point or Host A 102 and the second end point or Host B 112. Host A 102 in this case has two only locally valid IP addresses LA1 (204A), LA2 (204B) (in the example the IP addresses LA21=10.1.1.1 and LA2=10.2.2.2 have been selected), which are translated by NAT routers 206A and 206B into global addresses GA1 (216A), GA2 (216B) (in the example the IP addresses GA21=139.21.5.5 and GA2=140.20.6.6 have been selected). Host B 112 has two global IP addresses B1 (114A) and B2 (114B). To simplify the diagram the ports are not shown in FIG. 2.

An SCTP association between the end points A and B is formed by two paths 208A, 208B, with the first path 208A connecting the local address LA1 of the Host A via the first NAT router N1 (206A), the translation relationship LA21 <==> GA1 and the optional WAN 110 with the first address B1 of the Host B. The second path 208B connects the local address LA2 of the Host A via the second NAT router N2 (206B), the translation relationship LA2 <==> GA2 and the optional WAN 110 to the second address B2 of the Host B.

There can be various reasons for the arrangement of the Host A in a separate network with only locally valid IP addresses LA1, LA2. A possible is the scarcity of global IP addresses which makes it necessary to use this resource sparingly and for example design large corporate networks as private networks with private, i.e. only locally valid addresses which are not addressable from the Internet. A further possible reason is security considerations, since in many cases simply designing a network as a private network, where necessary supplemented by NAT routers with firewall functions or separate firewalls, is a significant security benefit.

However it is not possible with the SCTP protocol in accordance with RFC 2960 to establish an SCTP association with two paths 208A, 208B in accordance with FIG. 2, since in the SCTP connection setup the further sender addresses are transmitted in a message flow of the connection request message over the first path.

In the example in FIG. 1 the connection is established starting at A by using the first address of A, A1, as the sender address of the connection request message and entering the second address of A, A2, in a message flow of this message. On receipt of this message at B all the required information for setting up the two paths is available.

In the example in FIG. 2 on the other hand B would receive the translated first address GA1 and the non-translated local address LA2, so that the second path 208B cannot be established. The first NAT router 206A also has no opportunity of determining the translation of the address LA2 to the address GA2 in the second router.

To enable the connection in accordance with FIG. 2 to be established despite this, the address translation relationships LA1 <==> GA1 and LA2 <==> GA2 are first determined in order to enable the two-path SCTP association to be subsequently created.

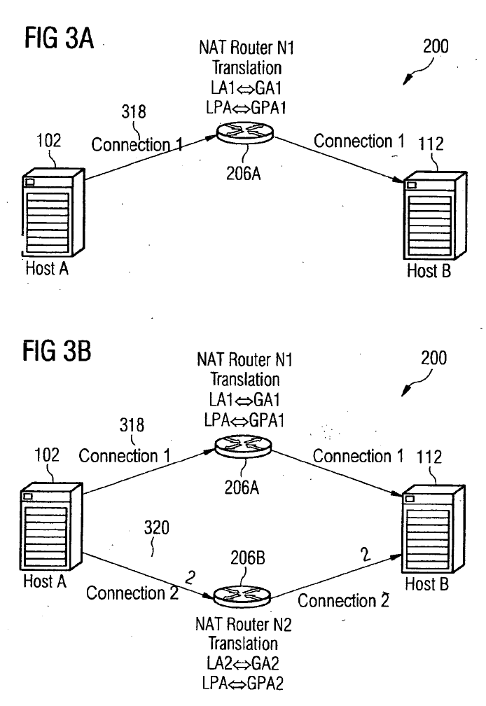

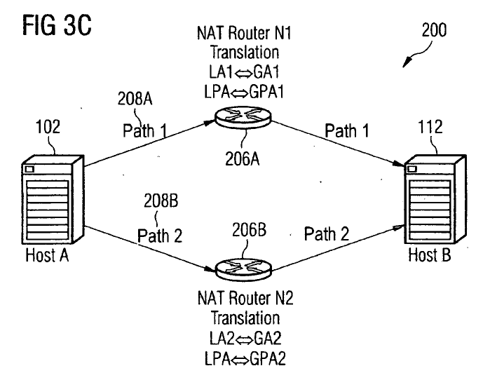

FIG. 3A-C show a typical execution sequence in accordance with which two single-homed data connections are established (FIG. 3A-B) and subsequently are merged or coalesced into a common SCTP association. To simplify the diagram FIGS. 3A-C do not show the WAN 110 and the address 204, 114, 216.

FIG. 3A shows the first step in setting up the multi-homed connection, the determination of the first address translation LA1 <==> GA1. The first address translation is determined in the example shown in FIG. 3 in that a first connection 318 of the first local address LA1 of Host A is established to the first (global) address B1 of Host B. It is assumed here that this connection 318 is routed via the first NAT router 206A. The connection is a classical “single-homed” connection or association. The following table illustrates the relationships for connection 318:

| | Host A: | Host B: |
|---|---|---|
| First own IP address | LA1 | B1 |
| Second own IP address | — | — |
| Own port | LPA1 | PB1 |
| First partner IP address | B1 | GA1 |
| First partner port | PB1 | GPA1 |
| Second partner IP address | — | — |
| Second partner port | — | — |
| Own verification tag | VTA1 | VTB1 |
| Partner verification tag | VTB1 | VTA1 |

Where:
LA1: First local address of the Host A
B1: First (global) address of the Host B
LPA1: First local port of the Host A (for LA1)
PB1: First port of the Host B (for B1)
GA1: First global address, LA1 <==> GA1
VTA1: Verification tag of Host A for the first connection
VTB1: Verification tag of host B for the first connection

The verification tags VTA1, VTB1 obtain their meaning later in conjunction with the merging of the two data connections and are explained in greater detail in conjunction with FIG. 3C. As a result of the step of FIG. 3A the first address translation relationship LA1 <==> GA1 is now determined.

FIG. 3B shows the second step in establishing the multi-homed connection, the determination of the second address translation LA2 <==> GA2. The second address translation is determined in the example shown in FIG. 3, in that a second connection 320 is established from the second local address LA2 of Host A to the second (global) address B2 of Host B. It is assumed that this connection 320 is routed via the second NAT router 206B. The connection is also a classical “single-homed” connection or association. Alternatively a single-homed connection of type “merge only” can be created (this type is explained in greater detail below). The following table illustrates the relationships for connection 320:

| | Host A: | Host B: |
|---|---|---|
| First own IP address | LA2 | B2 |
| Second own IP address | — | — |
| Own port | LPA2 | PB2 |
| First partner IP address | B2 | GA2 |
| First partner port | PB2 | GPA2 |
| Second partner IP address | — | — |
| Second partner port | — | — |
| Own verification tag | VTA2 | VTB2 |
| Partner verification tag | VTB2 | VTA2 |

Where:
LA2: Second local address of the Host A
B2: Second (global) address of the Host B
LPA2: Second local port of the Host A (for LA2)
PB2: second port of the Host B (for B2)
GA2: Second global address, LA2 <==> GA2
VTA2: Verification tag of Host A for the second connection
VTB2: Verification tag of Host B for the second connection

As a result of the step of FIG. 3B the second address translation relationship LA2 <==> GA2 is now also known.

FIG. 3C shows the merging or linkage of the two data connections or associations 318 and 320 into the desired SCTP association 208 with the paths 208A and 208B. To this end, in the preferred exemplary embodiment, Host A 102 transmits via the first connection 318 an SCTP chunk ASCONF, as defined in the following Internet Draft of the IETF: http://www.ietf.org/internet-drafts/draft-ietf-tsvwg-addip-sctp-09.txt (referred to below as the addip draft), expanded by a parameter, which indicates to Host B 112 that a parallel association (here: second connection 310) is to be linked in as an additional address. This parameter, referred to below as “Merge SCTP Endpoint” uses the verification tags which are assigned to the individual connections or associations 318 and 320 on setup

The ASCONF chunk is defined as follows (extract from the above IETF Draft):

| | | |
|---|---|---|
| Stewart, et al. | Expires Dec. 9, 2004 | [Page 5] |
| Internet-Draft | SCTP Dynamic Address Reconfiguration | June 2004 |

3.1.1 Address reconfiguration Change chunk (ASCONF)
This chunk is used to communicate to the remote endpoint one of the reconfiguration change requests that MUST be
acknowledged. The information carried in the ASCONF chunk uses the form of a Type-Length-Value (TLV), as described
in “3.2.1 Optional/Variable-length Parameter Format” in RFC2960 [6], for all variable parameters.

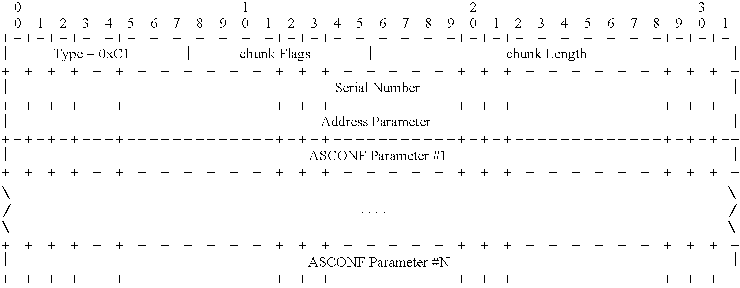

Serial Number: 32 bits (unsigned integer)
This value represents a Serial Number for the ASCONF chunk. The valid range of Serial Number is from 0 to 4294967295
(2**32 - 1). Serial Numbers wrap back to 0 after reaching 4294967295.
Address parameter: 8 or 20 bytes (depending on type)
This field contains an address parameter, either IPv6 or IPv4, from RFC2960 [6]. The address is an address of the
Transmitter of the ASCONF chunk, the address MUST be considered part of the association by the peer endpoint (the
receiver of the ASCONF chunk). This field may be used by the receiver of the ASCONF to help in finding the associa-
tion. This parameter MUST be present in every ASCONF message i.e. it is a mandatory TLV parameter.
Note the host Name address parameter is NOT allowed and MUST be ignored IF received in any ASCONF message.
ASCONF parameter: TLV format
Each Address reconfiguration change is represented by a TLV parameter as defined in Section 3.2. One or more requests
may be present in an ASCONF chunk.

The ASCONF chunk is assigned an ASCONF ACK chunk which is defined as follows (extract from the above IETF Draft):

3.1.2 Address Configuration Acknowledgment chunk (ASCONF-ACK)
This chunk is used by the receiver of an ASCONF chunk to acknowledge the reception. It carries zero or more results
for any ASCONF Parameters that were processed by the receiver.

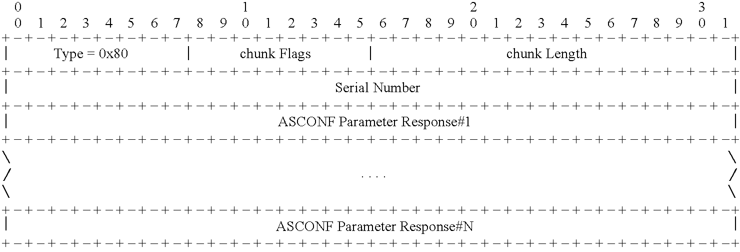

Serial Number: 32 bits (unsigned integer)
This value represents the Serial Number for the received ASCONF chunk that is acknowledged by this chunk. This value
is copied from the received ASCONF chunk.
ASCONF Parameter Response TLV format
The ASCONF Parameter Response is used in the ASCONF-ACK to report status of ASCONF processing. By default, if a
responding endpoint does not include any Error Cause, a success is indicated. Thus a sender of an ASCONF-ACK MAY
indicate complete success of all TLVs in an ASCONF by returning only the chunk Type, chunk Flags, chunk Length (set
to 8) and the Serial Number.

This value represents the Serial Number for the received ASCONF chunk that is acknowledged by this chunk. This value is copied from the received ASCONF chunk.
ASCONF Parameter Response: TLV format
The ASCONF Parameter Response is used in the ASCONF-ACK to report status of ASCONF processing. By default, if a responding endpoint does not include any Error Cause, a success is indicated. Thus a sender of an ASCONF-ACK MAY indicate complete success of all TLVs in an ASCONF by returning only the chunk Type, chunk Flags, chunk Length (set to 8) and the Serial Number.

The following new parameters are defined (in addition to or instead of the SCTP parameters already provided by the above draft) in order to support or merge connections or associations (Table 1: Parameters for ASCONF chunks; Table 2: Parameters for INIT/INIT-ACK chunks):

New parameter types

TABLE 1
Parameters for use in the ASCONF parameters

| Address reconfiguration Parameters | Parameter Type |
|---|---|
| Merge SCTP Endpoint | 0xC005 |
| Delete SCTP Path | 0xC006 |
| Set Primary Path | 0xC007 |

TABLE 2
Parameters for use in the INIT/INIT-ACK chunk

| Address Configuration Parameters | Parameter Type |
|---|---|
| Merge Only | 0xC005 |

As is usual with SCTP there can be provision for an ABORT to be sent by the receiver of an invalid parameter.

The new parameters are explained in greater detail below (parameters shown in accordance with the IETF conventions):

Merge SCTP Endpoint (IP Address+Port)

The 12-byte parameter is used to inform the partner side about the request for a parallel association to be linked in as an additional address.

Merge SCTP Endpoint (IP Address + Port)
The 12-byte parameter is used to inform the partner side about the request for a parallel association to be linked in
as an additional address.

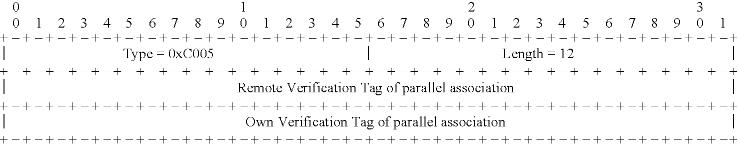

The parallel association must be resolved by the receiver of this parameter if the address is merged. The resolution is
signalled by the sending of an ABORT known from the SCTP for this parallel association.

To clear down an existing path again the Delete IP Address known from the addip draft cannot be used unchanged since no communication address—as was previously the norm—may be linked into the parameter. Instead of this the path to be removed is uniquely identified by the known translation relationship and the transmitter address of the packet which contains the parameter, and for example the following parameters can be used:

Delete SCTP Path
This 4 Byte ASCONF parameter is used to signal to the partner that the source address (+ port) of the chunk which
contains this parameter is to be removed from the list of the valid IP addresses. If this involves the last path, the
ASCONF is to be rejected.

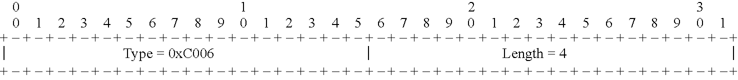

To identify the path as primary or preferred the parameter Set Primary Address known from the addip draft can for the same reason not be used unchanged. Instead of this the path to be flagged is uniquely identified by the known translation relationship and the transmitter address of the packet which contains the parameter, and for example the following parameters can be used:

Set Primary Path
This 4 Byte ASCONF parameter is used to signal to the partner that the source address (+ port) of the chunk which
contains this parameter is to be set as the primary path.

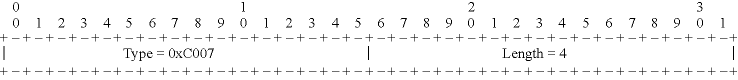

The parameter MERGE ONLY can only be used in an INIT/INIT-ACK chunk to establish a (single-homed) association only for the purposes of determining the address translation relationship. This temporary association should in this case not be used for the transport of data but only run the translation relationship and subsequently be linked to the parallel association:

Merge Only
This 4 Byte INIT/INI-ACK parameter is used to signal to the partner that the new association will be only temporarily
formed to expand another association by a further path.
Note: This association is not intended to be used for data transmission. The Parameter Advertised Receiver Window
Credit, Number of Inbound/Outbound Streams and Initial TSN should be set to 0 by the transmitter and ignored by the
receiver of the Merge Only parameter.

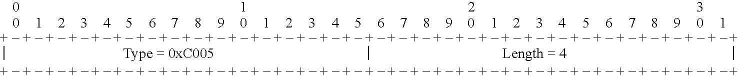

The merging shown in FIG. 3C of the two connections 318 and 320 from FIG. 3B to the association 208 can now take place by Host A transmitting the first connection 318 of an ASCONF chunk with the following format to Host B:

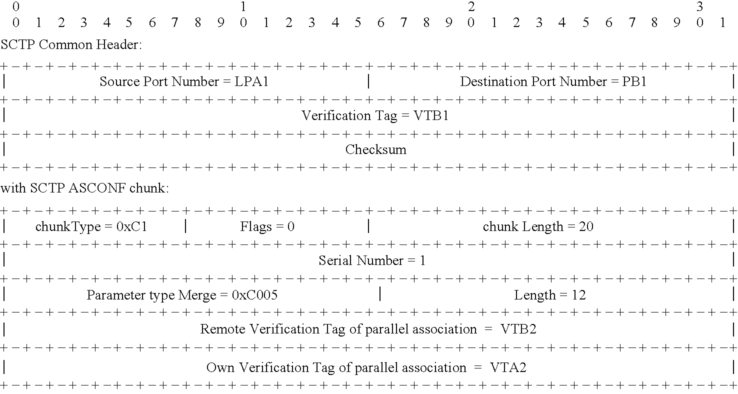

The verification tags will be checked at Host B. If the second association 320 has been established as a “Merge Only” type, this criterion can also be checked. A check can also be made as to whether the second association is active.

The checking of the verification tags is for the sake of security here in that this can prevent unauthorized components being linked into the connection.

If the check was successful, Host B ends the second connection 320, e.g. by sending an ABORT chunk via the connection it accepts the address GA2 with associated port GPA2 as the second address (and thereby as the second path) for the first connection 318 which in this way becomes a two-path association 208. Host B signals the successful conclusion of this merge via the first path 208A of the association 208, for example by means of the following ASCONF-ACK chunk:

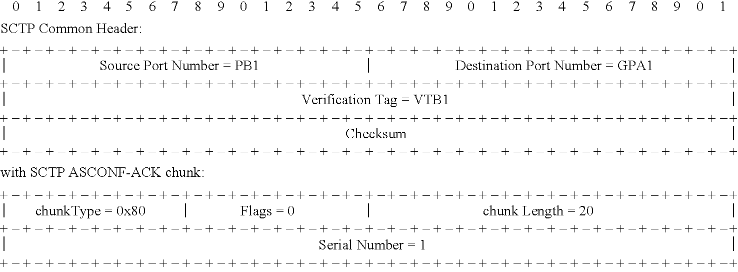

The result is the association 208 in accordance with the following overview

| | Host A: | Host B: |
|---|---|---|
| First own IP address | LA1 | B1 |
| Second own IP address | LA2 | B2 |
| First own port | LPA1 | PB1 |
| Second own port | LPA2 | PB2 |
| First partner IP address | B1 | GA1 |
| First partner port | PB1 | GPA1 |
| Second partner IP address | B2 | GA2 |
| Second partner port | PB2 | GPA2 |
| Own verification tag | VTA1 | VTB1 |
| Partner verification tag | VTB1 | VTA1 |

Subsequently one of the paths 208A, 208B can be defined as the primary path.

It should be pointed out that the protocols, messages, message elements and parameters described here merely reflect one of the many possible implementations of the invention. It is evident that the SCTP chunks and parameters described in detail would have to be adapted accordingly for other protocols to comply with the conventions applicable for these protocols, for example other acknowledgement or security mechanisms. Furthermore, starting from the described exemplary embodiments, it is evident how the teaching of the present invention can be applied for SCTP by using other chunks and parameters.

1. A method for establishing a multi-homed connection with a number n of paths between two components of a communication network, wherein each component comprises at least n communication addresses, and wherein a translation of the communication addresses of at least a first of the components is performed in a connection, the method comprising the following steps:
determining n translation relationships of the n communication addresses provided for the n paths, by the components; and
establishing the multi-homed connection by establishing the n paths on the basis of the determined translation relationships.

2. The method according to claim 1, wherein at least k of the n translation relationships are determined by exchanging test messages between the components for k of the communication addresses, wherein the translation of the communication addresses for the test messages is identical to the translation of the communication addresses for paths of the multi-homed connection.

3. The method according to claim 1, wherein at least m of the n translation relationships are determined by establishing m single-homed connections between the components.

4. The method according to claim 3, wherein the multi-homed connection is established by joining the m single-homed data connections to form m paths of the multi-homed connection.

5. The method in accordance to claim 1, wherein the multi-homed connection is a connection according to the suitably expanded Stream Control Transmission Protocol SCTP.

6. The method according to claim 5, wherein the SCTP protocol is employed with the following expansions:
setting up single-homed connections with verification tags; and
transmitting at least the verification tags of single-homed data connections to be joined using a “Merge SCTP Endpoint”-parameter included in a chunk of the type ASCONF.

7. The method in accordance to claim 2, wherein the multi-homed connection is a connection according to the suitably expanded Stream Control Transmission Protocol SCTP.

8. The method in accordance to claim 3, wherein the multi-homed connection is a connection according to the suitably expanded Stream Control Transmission Protocol SCTP.

9. The method in accordance to claim 4, wherein the multi-homed connection is a connection according to the suitably expanded Stream Control Transmission Protocol SCTP.

10. A component of a communication network, the component comprising:
at least n communication addresses, wherein a connection between the component and at least one further component of the communication network includes a translation of the communication addresses, the translation including translation relationships;
a mechanism for determining n of the translation relationships for n of the communication addresses provided for n paths; and
a mechanism for setting up a multi-homed connection with n paths by establishing the n paths based on the determined n translation relationships.

11. The component in accordance with claim 10, further comprising a mechanism for determining at least k of the n translation relationships, wherein the mechanism comprises means for exchanging test messages for k communication addresses between the component and the further component for providing k translation relationships, wherein the test messages are determined such that the translation of the communication addresses for test messages is identical to the translation of the communication addresses for paths of the multi-homed connection.

12. The component in accordance with claim 10, further comprising a mechanism for determining at least m of the n translation relationships, wherein the mechanism comprises means for setting up m single-homed connections between the components.

13. The component in accordance with claim 12, wherein the mechanism for setting up the multi-homed connection comprises means for joining the m single-homed connections to form m paths to the multi-homed connection.

14. The component in accordance with claim 10, further comprising a mechanism to set up multi-homed connections according to the Stream Control Transmission Protocol SCTP.

15. The component in accordance with claim 14, wherein the component supports the SCTP protocol with the following expansions:
setting up single-homed connections with verification tags; and
transmitting at least the verification tags of single-homed data connections to be joined using a “Merge SCTP Endpoint”-parameter included in a chunk of the type ASCONF.

16. The component in accordance with claim 11, further comprising a mechanism to set up multi-homed connections according to the Stream Control Transmission Protocol SCTP.

17. The component in accordance with claim 12, further comprising a mechanism to set up multi-homed connections according to the Stream Control Transmission Protocol SCTP.

18. The component in accordance with claim 13, further comprising a mechanism to set up multi-homed connections according to the Stream Control Transmission Protocol SCTP.
